(19) United States
(12) Patent Application Publication
(10) Pub. No.: US 2014/0258334 A1
(43) Pub. Date: Sep. 11, 2014

(54) INFORMATION PROCESSING APPARATUS, INFORMATION PROCESSING SYSTEM AND INFORMATION PROCESSING METHOD

(71) Applicant: Shinya MUKASA, Shizuoka (JP)

(72) Inventor: Shinya MUKASA, Shizuoka (JP)

(73) Assignee: RICOH COMPANY, LTD., TOKYO (JP)

(21) Appl. No.: 14/197,309

(22) Filed: Mar. 5, 2014

(30) Foreign Application Priority Data
Mar. 11, 2013 (JP) 2013-048397
Feb. 27, 2014 (JP) 2014-037009

(51) Int. Cl. G06F 21/62

(52) U.S. Cl. CPC G06F 21/6218
USPC 707/781

(57) ABSTRACT

An information processing apparatus includes a file obtaining information generating part that generates file obtaining information at based on at least a place at which a first file is stored; a combined file generating part that combines the file obtaining information generated by the file obtaining information generating part with the first file or a second file corresponding to the first file to generate a combined file; a request receiving part that receives a request that is based on the file obtaining information that is input to an external terminal unit by using the combined file generated by the combined file generating part; and a file managing part that carries out a process according to the request received by the request receiving part.

### BACKGROUND OF THE INVENTION

1. Field of the Invention

The present invention relates to an information processing apparatus that receives a request concerning a file stored in the information processing apparatus and carries out a process according to the request, an information processing system that includes the information processing apparatus, and an information processing method executed in the information processing system.

2. Description of the Related Art

Recently, the number of cases has increased where, in a conference, a presentation, or the like, participants view material using notebook-type Personal Computers (PCs), smart devices or the like. Further, in a case where material is distributed to participants using paper media, the participants may request a corresponding electronic file thereafter. In such a case, if a presenter distributes an electronic file to the participants via electronic mails or the like, the presenter transmits electronic mails or the like to all the participants, which may take much effort on the part of the presenter.

Further, there may be a case where material is replaced immediately before a conference, a presentation or the like, and it is difficult to know how many persons actually participate the conference, presentation or the like, which may take much effort on the part of the presenter, if the material is distributed to all the participants via electronic mails at the place of the conference, presentation or the like.

In such a case, each participant opens the electronic mail thus sent from the presenter, obtains an electronic file therefrom and views it, which may take much effort on the part of also each participant.

Japanese Laid-Open Patent Application No. 2011-018209 (Patent Reference No. 1) discloses a network projector that generates a directory that stores material to be projected for each conference. In the network projector, access by a user to the directory is controlled for each conference by using a random password. The password is included at an edge of an image that is projected by the network projector. As a result, only the persons who participate in the conference can know the password, and thus, the participants can easily share the presentation material during the conference in a secure manner.

### SUMMARY OF THE INVENTION

According to one aspect of the present invention, an information processing apparatus includes a storing part that stores a first file; a file obtaining information generating part that generates file obtaining information based on at least a place at which the first file is stored in the storing part; a combined file generating part that combines the file obtaining information generated by the file obtaining information generating part with the first file or a second file corresponding to the first file to generate a combined file; a request receiving part that receives a request that is based on the file obtaining information that is input to an external terminal unit by using the combined file generated by the combined file generating part; and a file managing part that carries out a process according to the request received by the request receiving part.

Other objects, features and advantages of the present invention will become more apparent from the following detailed description when read in conjunction with the accompanying drawings.

### BRIEF DESCRIPTION OF THE DRAWINGS

FIG. 1 illustrates an example of the overall configuration of an embodiment;

FIG. 2 is a block diagram showing a hardware configuration example of a file server shown in FIG. 1;

FIG. 3 is a block diagram showing a hardware configuration example of a smart device shown in FIG. 1;

FIG. 4 is a block diagram showing a hardware configuration example of a projector shown in FIG. 1;

FIG. 5 is a block diagram showing functional configuration examples of the smart device and the file server according to a first embodiment;

FIGS. 6A, 6B, 6C and 6D illustrate examples of processing when the file server combines a QR code with an uploaded file;

FIG. 7 is a flowchart illustrating one example of a flow of processing in which the file server combines a QR code with an uploaded file and stores it according to the first embodiment;

FIG. 8 is a flowchart illustrating one example of a flow of processing in which the smart device requests a file from the file server so as to view the file on the smart device according to the first embodiment;

FIG. 9 is a block diagram showing functional configuration examples of a smart device and a file server according to a second embodiment;

FIG. 10 is a flowchart illustrating one example of a flow of processing in which the file server combines a QR code with an uploaded file and stores it according to the second embodiment;

FIG. 11 is a flowchart illustrating one example of a flow of processing in which the smart device requests a file from the file server so as to view the file on the smart device according to the second embodiment;

FIG. 12 is a block diagram showing functional configuration examples of a smart device and a file server according to a third embodiment; and

FIG. 13 is a flowchart illustrating one example of a flow of processing in which the smart device requests a file from the file server so as to view the file on the smart device according to the third embodiment.

### DETAILED DESCRIPTION OF THE EMBODIMENTS

Below, using figures, the embodiments will be described in detail.

For the sake of convenience, first, a problem to be solved by the embodiments will be described.

As mentioned above, a troublesome procedure may be required when transmitting electronic files to all participants via electronic mails.

Further, according to a method disclosed by Patent Reference No. 1, a participant needs to access a file server and input a password, which may take complicated effort on the part of the participant.

The embodiments of the present invention have been devised in consideration of the problem, and an objective of the embodiments is to make it possible that, when a request concerning a predetermined file stored in an information processing apparatus is received and a process according to the request is carried out, the process according to the request can be carried out without taking complicated effort.

In the configuration disclosed by Patent Reference No. 1, when a password is input, access to a directory that stores material to be projected is allowed, which may take effort in accessing the directory, inputting the password and so forth.

In contrast thereto, according to the embodiments of the present invention, a participant can view an electronic file that is material while security is kept without taking complicated effort on the part of the presenter and the participant of a conference, a presentation or the like.

That is, according to the embodiments, when a file is stored in a file server by a presenter of a conference, a presentation or the like, the file server carries out the following processes. That is, a QR code (registered trademark) that includes three items of information, i.e., the IP address of the file server, a path toward the file (file path) and an access ID and combines the QR code with an image of the file.

The image of the file with which the QR code is thus combined is projected to a screen or the like by a projector or is printed to create a document. Then, the image together with the QR code is shown to participants of a conference, a presentation or the like. The participants operate own terminal units to cause them to read the QR code included in the shown image. Then, the terminal units send file requests to the file server, respectively.

In response to the respective file requests, the file server returns the files to the respective terminal units that sent the file requests. Alternatively, the file server responds to the respective file requests and brings the file into a state such that the terminal units that sent the file requests are allowed to access the file.

As a result, the participants can obtain or view, through their own terminal units, the material (electronic files) prepared by the presenter of the conference or presentation without taking complicated effort on the part of the presenter and the participants.

Further, by preparing a file for projection and a file for distribution separately and/or including information of an access ID in the QR code, it is possible to ensure the security.

That is, by preparing a file for projection and a file for distribution separately and including the QR code only in the file for projection, the QR code is not included in the file for distribution that is actually distributed to the participants. As a result, it is possible to prevent information included in the QR code from being leaked through the file for distribution. As a result, it is possible to prevent a third party other than the participants of the conference, presentation or the like from using information included in the QR code through the file for distribution to obtain the file for distribution. Thus, it is possible to ensure security.

Further, by including information of an access ID in the QR code, it is possible to carry out access control for a file stored by the file server through the access ID as will be described later. As a result, it is possible to prevent a third party other than the participants of the conference, presentation or the like from accessing and obtaining the file. Note that an access ID is one example of validity information and the conference, presentation or the like is one example of the predetermined purpose of using a first file.

Below, using the drawings, the embodiments of the present invention will be described in detail.

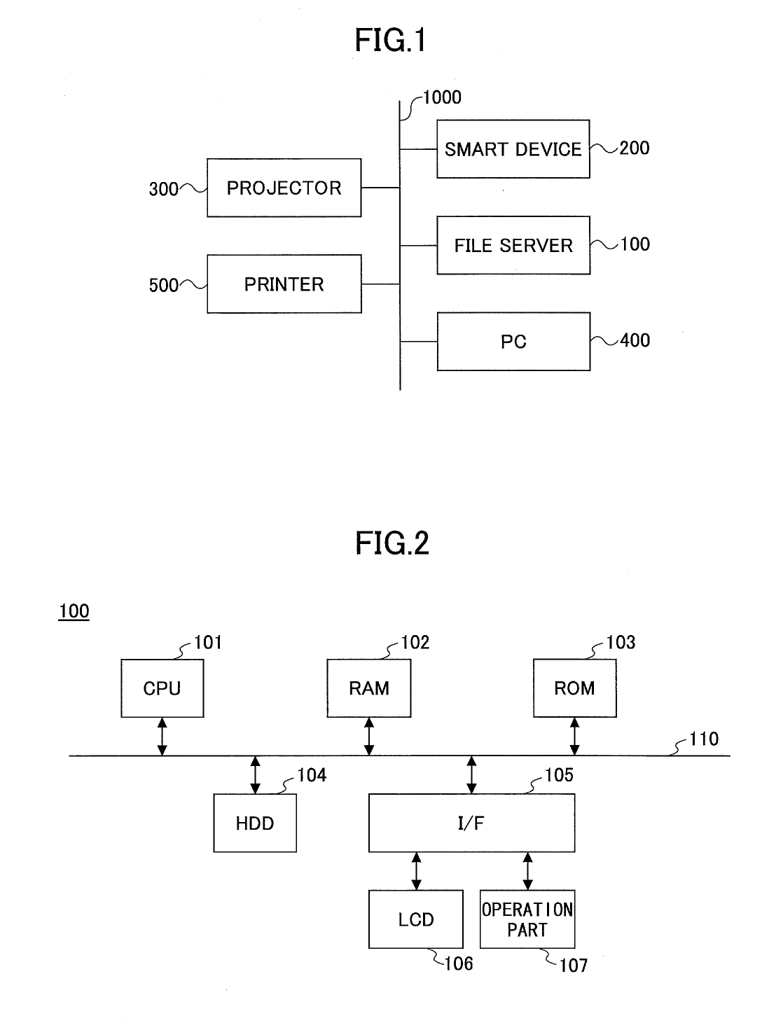

FIG. 1 illustrates an example of a general overall configuration of an information processing system according to the first or second embodiment.

As shown in FIG. 1, the information processing system according to the first or second embodiment includes a file server 100, a smart device 200, a projector 300, a Personal Computer (PC) 400 and a printer 500, which are connected together via a network 1000 in a mutually communicatable manner. The network 1000 may be a wireless communication network, a wired communication network or a combination of a wireless communication network and a wired communication network.

Note that in the first embodiment, the printer 500 is not necessary, and the projector 300 is not necessary in the second embodiment. However, it is also possible to include both the projector 300 and the printer 500 in the information processing system so that the functions of both the first and second embodiments can be implemented in the information processing system.

Further, in the embodiments, as will be described later, the PC 400 is used as a terminal unit of the presenter of a conference or the like. However, instead of a PC, a smart device can be used as a terminal unit of the presenter of a conference or the like.

Further, when the information processing system is used for distributing material for the purpose of a conference, presentation or the like, it is assumed that the presenter of the conference, presentation or the like has the PC 400, and the participants have the smart devices 200, respectively. Therefore, when a plurality of the participants participate the conference, presentation or the like, each thereof has his or her own smart device 200. That is, it is assumed that the same number of smart devices 200 as the number of the participants are used, and the respective smart devices 200 are connected together via the network 1000 in a mutually communicatable manner also together with the file server 100 and so forth.

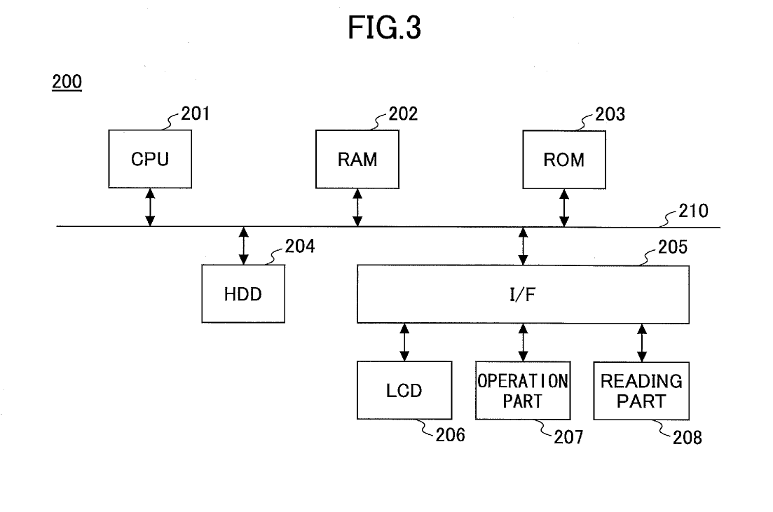

Next, using FIG. 2, a hardware configuration example of the file server 100 will be described.

The file server 100 has a configuration same as or similar to a common information processing terminal.

The file server 100 includes a Central Processing Unit (CPU) 101, a Random Access Memory (RAM) 102, a Read Only Memory (ROM) 103, a Hard Disk Drive (HDD) 104 and an Interface (I/F) 105. These devices are connected together via a bus 110 in a mutually communicable manner.

Further, a Liquid Crystal Display (LCD) 106 and an operation part 107 are connected to the I/F 105.

The CPU 101 carries out arithmetic and logic operations and controls operations of the entirety of the file server 100.

The RAM 102 is a volatile recording medium on which reading and writing can be carried out at high speed and the CPU 101 uses it as a work area when processing information.

The ROM 103 is a nonvolatile recording medium on which only reading is allowed and a program such as firmware is stored therein.

The HDD 104 is a nonvolatile recording medium on which reading and writing can be carried out and stores an Operating System (OS), various sorts of control programs, application programs and so forth.

The I/F 105 is used as an interface for connecting the bus 110 with various sorts of hardware, networks and so forth. Specifically, the I/F 105 is used as an interface for connecting via the bus 110 the LCD 106 and the operation part 107 to other devices (the CPU 101 and so forth) in the file server 100. Further, the I/F 105 is also used as an interface for connecting via the network 1000 shown in FIG. 1 the file server 100 with other devices (for example, the smart devices 200) in the information processing system.

The LCD 106 is a visual user interface for a user to know states in the file server 100.

The operation part 107 provides a user interface such as a keyboard, a mouse and/or the like, for a user to input information to the file server 100.

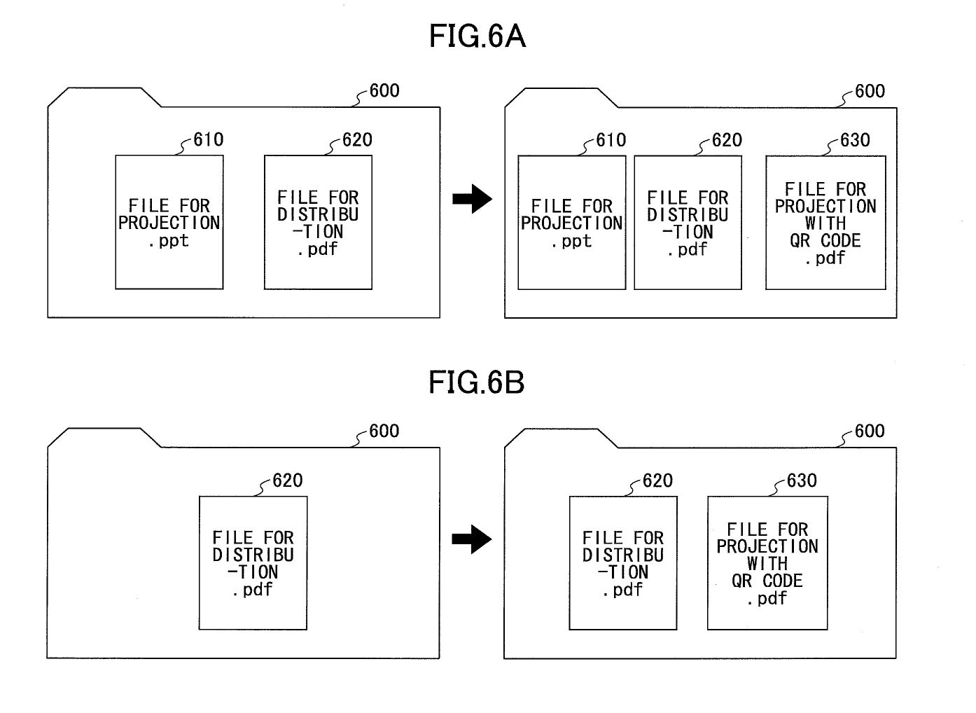

In the file server 100, the CPU 101 reads various sorts of control programs installed in, for example, the HDD 104, loads them in the RAM 102, executes them and thus implements the functions of various functional parts described later using FIGS. 5-13.

Note that the various sorts of control programs can be downloaded from another server (not shown) via the network 1000 and installed in the HDD 104. Alternatively, they can be previously stored in a portable recording medium such as a SD card, a CD-ROM, a Universal Serial Bus (USB) memory or the like and can be read therefrom via the I/F 105 and installed in the HDD 105.

Further, the PC 400 shown in FIG. 1 has a hardware configuration the same as or similar to that of the file server 100 described above.

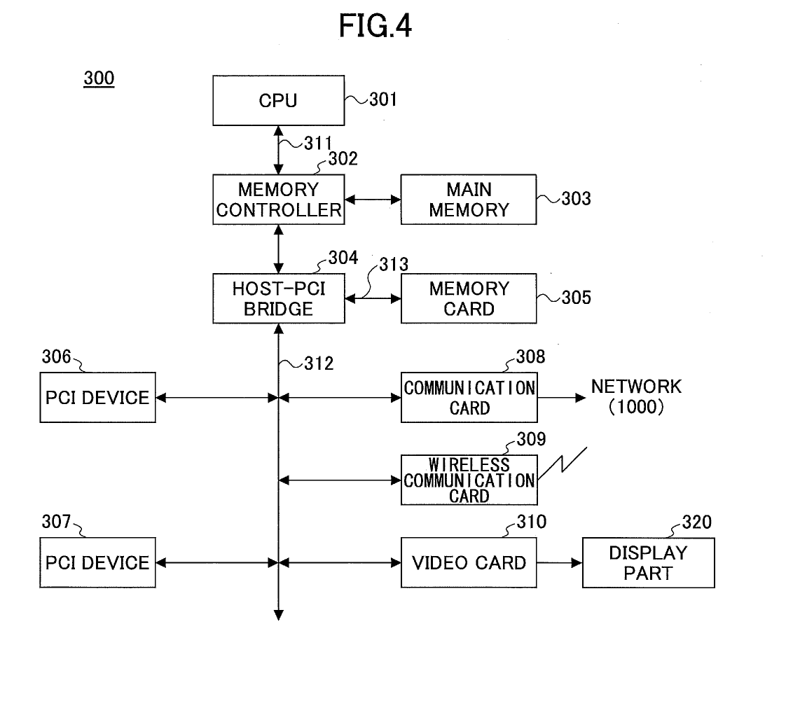

Next, using FIG. 3, a hardware configuration example of the smart device 200 will be described.

The smart device 200 has a CPU 201, a RAM 202, a ROM 203, a HDD 204 and an I/F 205, which are connected together via a bus 210 in a mutually communicatable manner. The CPU 201, the RAM 202, the ROM 203, the HDD 204 and the I/F 205 have configurations and functions the same as or similar to those of the CPU 101, the RAM 102, the ROM 103, the HDD 104 and the I/F 105 described above using FIG. 2 and duplicate description will be omitted.

That is, the smart device 200 has a configuration and functions the same as or similar to those of the file server 100. Further, the smart device 200 has a reading part 208 together with a LCD 206 and an operation part 207 connected with the bus 210 via the I/F 205. The reading part 208 is, for example, a camera, and is used for reading a QR code as will be described later.

Note that, instead of the smart device 200, it is possible to use a PC having a camera function.

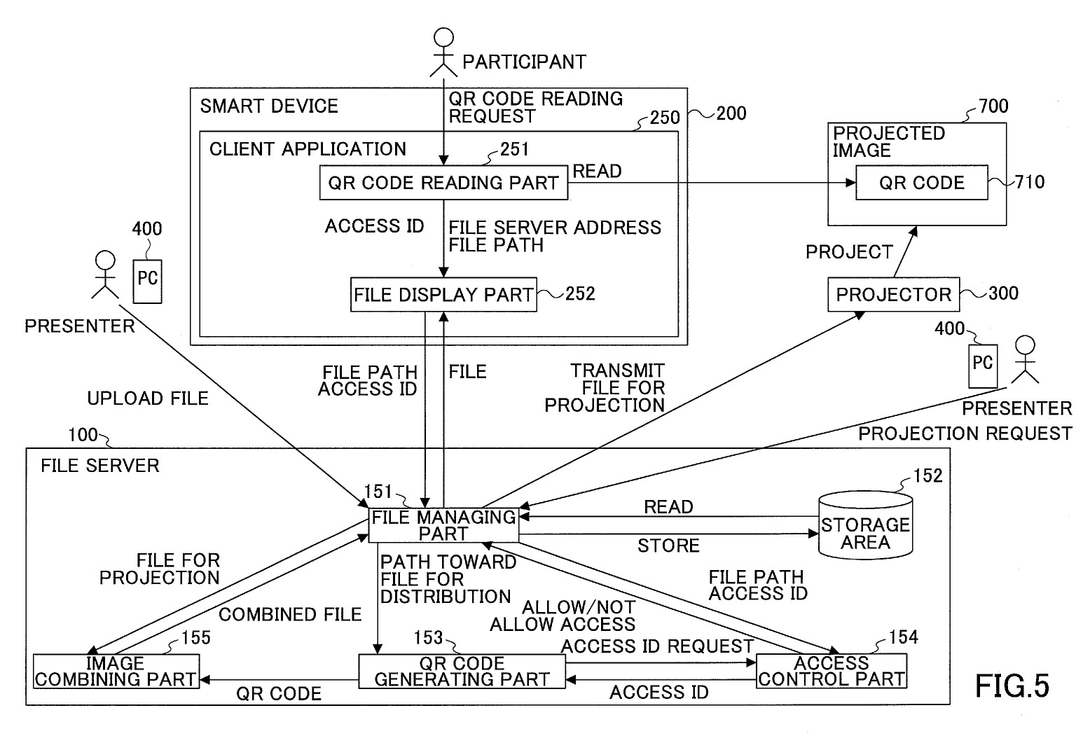

Next, using FIG. 4, a hardware configuration example of the projector 300 will be described.

The projector 300 includes a CPU 301, a memory controller 302, a main memory 303 and a host-Peripheral Component Interconnect (PCI) bridge 304.

The memory controller 302 is connected with the CPU 301, the main memory 303 and the host-PCI bridge 304 via a host bus 311. The CPU 301 carries out control of the entirety of the projector 300. The memory controller 302 controls reading, writing and so forth on the main memory 303. The main memory 303 is a system memory to be used as a memory for storing programs and/or data, a memory for developing programs and/or data, a memory for drawing images and/or the like.

The host-PCI bridge 304 is a bridge for connecting a peripheral device or a PCI device. The host-PCI bridge 304 is connected with a memory card 305 through a HDD I/F 313. Further, the host-PCI bridge 304 is connected with PCI devices 306 and 307 through a PCI bus 312. Further, the host-PCI bridge 304 is connected with a communication card 308, a wireless communication card 309, a video card 310 and so forth through a PCI bus 312 and PCI slots (not shown).

The memory card 305 is used as a boot device. The communication card 308 and the wireless communication card 309 are used to connect to the network 1000.

The video card 310 is used for projecting an image on a screen (not shown) or the like and outputs a video signal to a display part 320. The display part 320 displays the image based on the video signal and displays the image on the screen or the like in a magnifying manner.

Note that a control program executed in the projector 300 is provided in a manner of being previously incorporated at a storage memory in the main memory 303, for example.

As to a hardware configuration example of the printer 500, it is possible to employ a hardware configuration the same as or similar to a common printer connectable with a network, and a description thereof will be omitted.

Next, the first embodiment will be described using FIGS. 5-8.

First, using FIG. 5, functional configuration examples of the smart device 200 and the file server 100 having the above-described hardware configurations according to the first embodiment will be described.

As shown in FIG. 5, in the smart device 200, a client application 250 is installed as an application program. The client application 250 includes a QR code reading part 251 and a file display part 252. The client application 250 is installed in, for example, the HDD 204, is loaded in the RAM 202 by the CPU 201 and is executed by the CPU 201. As a result, respective functions of the QR code reading part 251 and the file display part 252 described later are implemented.

According to a request from a participant of a conference or a presentation (hereinafter, simply referred to as a “participant”), who is a user of the smart device 200, the QR code reading part 251 reads a QR code using the reading part 208. According to the first embodiment, the QR code is shown to the participant in a state of being included in a projected image 700 projected by the projector 300 onto a screen or the like. The projected image 700 is an image obtained as a result of an image stored in a form of a “file for projection” in a storage area 152 in the file server 100 being transmitted to the projector 300 in response to a projection request that is input by the presenter and thus being projected onto the screen or the like by the projector 300.

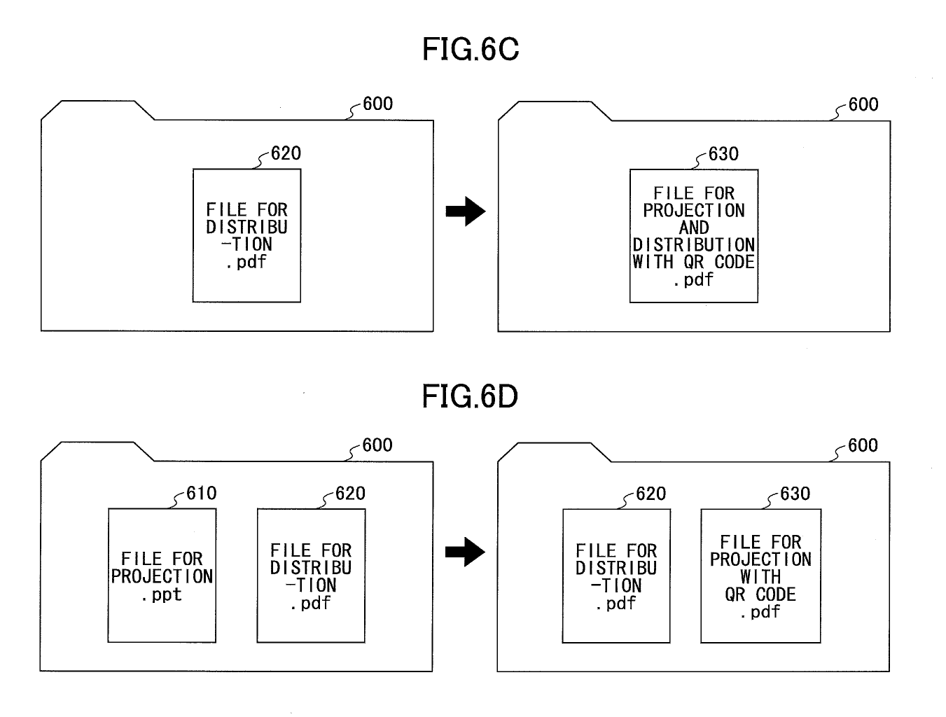

Further, the “file for projection” and the “file for distribution”, for example, have the mutually same or similar contents and are prepared by the presenter as material for the conference, the presentation or the like. These files will be described later using FIGS. 6A-6D, for example.

The QR code reading part 251 decodes the read QR code and obtains the IP address of the file server 100, a file path toward the “file for distribution” in the storage area 152 in the file server 100 and an access ID therefrom.

The file display part 252 accesses the file server 100 using the information thus obtained by the QR code reading part 251, obtains the file for distribution from the file server 100 and displays it on the LCD 206 in the own device. That is, by using the IP address of the file server 100 included in the information obtained by the QR code reading part 251, the file display part 252 accesses the file server 100. Further, using the file path toward the “file for distribution” (hereinafter, simply referred to as a “file path”), the file display part 252 reaches the file for distribution by tracing a hierarchy in the storage area 152.

Further, using the access ID included in the information obtained by the QR code reading part 251, an access control part 154 in the file server 100 carries out access control (described later). When the access ID does not correspond to a restriction by the access control and allows access to the file for distribution, a file managing part 151 reads the file for distribution from the storage area 152 and transmits it to the smart device 200 that requested it. Alternatively, the file managing part 151 allows the smart device 200 that requested it to access the file for distribution stored in the storage area 152. As a result, the participant who is the user of the smart device 200 can view the transmitted file for distribution on the LCD 206 in the own device. Alternatively, as a result of the own device accessing the file for distribution in the storage area 152 in the file server 100, the participant can view the file for distribution on the LCD 206 in the own device.

The file server 100 includes the file managing part 151, the storage area 152, a QR code generating part 153, the access control part 154 and an image combining part 155.

Thereamong, respective functions (described later) of the file managing part 151, the QR code generating part 153, the access control part 154 and the image combining part 155 are implemented, for example, as follows. That is, a control program installed in the HDD 104 is loaded in the RAM 102 by the CPU 101, the CPU 101 executes the control program and thus implements these functions.

Further, the storage area 152 is provided in the RAM 102 or the HDD 104 and is managed by the file managing part 151.

The file managing part 151 stores the file for projection and the file for distribution that are uploaded from the PC 400 of the presenter. Further, in response to the file request from the smart device 200, the file mangling part 151 returns the file for distribution that is requested by the file request to the smart device 200 or allows the smart device 200 that requested it to access the file for distribution. Further, in response to the projection request from the presenter via the PC 400, the file managing part 151 transmits the file for projection to the projector 300. The projector 300 receives the transmitted file for projection, projects the image of the file for projection on the screen or the like as the projected image 700 and thus shows it the respective participants.

The QR code generating part 153 generates the QR code including the three items of information, i.e., the file path toward the file for distribution that is uploaded by the presenter in the storage area 152, the IP address of the file server 100 and the access ID received from the access control part 154. Then, the QR code generating part 153 provides the generated QR code to the image combining part 155. That is, the QR code generating part 153 generates the QR code by encoding the above-mentioned three items of information together and provides the generated QR code to the image combining part 155.

The image combining part 155 embeds the QR code received from the QR code generating part 153 in the file for projection received from file managing part 151. Specifically, the following four methods (1), (2), (3) and (4) can be considered as a method of thus embedding (adding) the QR code.

(1) When a PowerPoint (PPT) file for projection 610 and a Portable Document Format (PDF) file for distribution 620 are uploaded from the PC 400 of the presenter, the file managing part 151 carries out the following process. That is, the file managing part 151 stores these two files in a predetermined folder 600 in the storage area 152 (see FIG. 6A). Then, the file managing part 151 converts the PPT file for projection 610 (one example of a second file) into a PDF file 630 (the reason for leaving the original file 610 will be described later). Simultaneously, the file managing part 151 adds the image 710 of the QR code including the path (file path) toward the PDF file for distribution 620 (one example of a first file) to the PDF file 630. The PDF file for projection 630 (one example of a combined file) to which the image 710 of the QR code is thus added is transmitted to the projector 300 and is projected onto the screen or the like by the projector 300. As a result, the image 710 of the QR code included in the projected image 700 is projected onto the screen or the like and is shown to the participants.

(2) As shown in FIG. 6B, when the PDF file for distribution 620 (one example of a first file) is uploaded, the file managing part 151 stores the file 620 in a predetermined folder 600 in the storage area 152 and copies the PDF file for distribution 620 to obtain a copy, i.e., a PDF file 630 (one example of a second file). Then, the file managing part 151 adds the image 710 of the QR code including the path (file path) toward the PDF file for distribution 620 (file path) to the PDF file 630 (the copy). The thus obtained PDF file 630 for projection (one example of a combined file) to which the image 710 of the QR code is thus added is actually used for projection by the projector 300.

(3) As shown in FIG. 6C, when the PDF file for distribution 620 (one example of a first file) is uploaded, the file managing part 151 stores the file 620 in a predetermined folder 600 in the storage area 152. Then, the file managing part 151 adds the image 710 of the QR code including the path (file path) toward the PDF file for distribution 620 to the same PDF file for distribution 620. That is, the file for distribution 620 to which the image 710 of the QR code is added is overwritten to the original file 620 and becomes a file 630. Thus, the PDF file for distribution and projection 630 to which the image 710 of the QR code is added is used, as it is, as a PDF file for projection, to be actually projected by the projector 300.

Note that the file for distribution 620 in FIG. 6C is not limited to a PDF file and a PPT file can be used instead.

(4) As shown in FIG. 6D, when both the PPT file for projection 610 (one example of a second file) and the PDF file for distribution 620 (one example of a first file) are uploaded, the file managing part 151 carries out the following process. That is, the file managing part 151 stores the two files 610 and 620 in a predetermined folder 600 in the storage area 152. Then, the file managing part 151 adds the image 710 of the QR code including the path (file path) toward the PDF file for distribution 620 to the file for projection 610. That is, the PDF file for projection 610 to which the image 710 of the QR code is thus added is overwritten to the original PPT file for projection 610 and becomes a file 630. The PDF file for projection 630 (one example of a combined file) to which the image 710 of the QR code is thus added is actually used for projection by the projector 300.

Note that, in the method of FIG. 6A, the reason for converting the PPT file 610 into the PDF file 630 is as follows. That is, an application program (for example, Acrobat) that can open a PDF file is a common and is considered to be installed in many computers. On the other hand, an application program (for example, PowerPoint) that can open a PPT file is not so common and is not considered to be installed in many computers. A case will be assumed that, in the file server 100, no application program that can open a PPT file is installed, but an application that can open a PDF file is installed. Even in such a case, by thus converting the PPT file for projection 610 into the PDF file 630, it is possible to add the image 710 of the QR code to the thus obtained PDF file 630. Note that the conversion from a PPT file into a PDF file can be carried out by the above-mentioned application program, Acrobat.

In the case of the method of FIG. 6C, the single file 630 is the file for projection and also is the file for distribution in common. Therefore, in response to the file request from each participant via the corresponding smart device 200, the file 630 to which the image 710 of the QR code is added is distributed or access to the file is allowed. Therefore, in comparison to a case where the file for distribution and the file for projection are stored separately (see FIGS. 6A and 6B), the case of the method of FIG. 6C is less preferable from a security viewpoint. However, in the case of the method of FIG. 6C, only one file (or one sort of files) is to be stored for each conference, presentation or the like, and therefore, it is advantageous that management of files is easy and also the required storage capacity can be reduced.

A specific method of the embedding (adding) the QR code can be such that, a new page is inserted before the first page of the file for projection and the image 710 of the QR code is pasted on the new page. Alternatively, it is also possible to previously create a blank at a predetermined part of the file for projection and paste the image 710 of the QR code in the blank part.

Further, according to the first embodiment, files for projection and/or files for distribution may be PPT files and/or PDF files. However, a file format is not limited to a PDF file and/or a PPT file. For example, PDL (for example, RPCS, PS or the like) or the like can be used.

Returning to the description of FIG. 5, the access control part 154 generates the access ID and controls access to the file for distribution from the outside of the file server 100.

Specific examples of the access control (whether to allow access) are the following ones (1) and (2).

(1) When the same access ID is used by one or a plurality of smart devices 200 a predetermined number of times in total, access to the corresponding file for distribution is not allowed thereafter and access by the smart device 200 is not allowed. The predetermined number of times is one example of a “number of times for allowing execution of a process according to a request”.

(2) A time limit is previously provided for each access ID when the access ID is generated. Then, when the time limit has elapsed after the generation of the access ID, access to the corresponding file for distribution is not allowed thereafter and access by the smart device 200 is not allowed. The predetermined number of times is one example of a “number of times for allowing a process according to a request”. The time limit is one example of a “time for allowing execution of a process according to a request”.

Both the above-mentioned examples (1) and (2) can be combined. That is, it is also possible that, when at least one of a condition that the same access ID is used the predetermined number of times in total and a condition that the time limit has elapsed for the access ID is satisfied, access to the corresponding file for distribution is not allowed thereafter.

Note that when access to the file for distribution is thus not allowed, the access control part 154 sends a notification to the smart device 200 that requested it indicating this point.

On the other hand, when access to the file for distribution is allowed, i.e., when the condition of not allowing access is not satisfied, the file for distribution requested by the smart device 200 is read from the storage area 152. Then, the read file for distribution is returned to the client application 250 of the smart device 200 that requested the file. Alternatively, access to the file for distribution in the storage area 152 requested by the smart device 200 by the client application 250 of the smart device 200 that requested it is allowed.

Note that reading the requested file for distribution from the storage area 152 and sending it to the client application 250 of the smart device 200 that requested it is one example of execution of a process according to a request. Further, allowing the client application 250 of the smart device 200 that requested the file for distribution to access the file for distribution in the storage area 152 is another example of execution of a process according to a request.

Note that according to the first embodiment, the file server 100 is directly connected with the projector 300. However, it is also possible to connect the projector 300 via a PC or a smart device with the file server 100. That is, for example, the projector 300 can be connected with the file server 100 via the PC 400 of the presenter. That is, it is possible that in response to the projection request by the presenter, the file server 100 returns the file for projection to the PC 400, and the presenter transmits the file for projection to the projector 300 after receiving the file for projection at the PC 400.

Further, according to the first embodiment, a QR code is used. However, it is also possible to use a bar code other than a QR code, or it is possible to use a code other than a bar code. That is, as long as the client application 250 in the smart device 200 can recognize or decode a code or the like and obtain the above-mentioned three items of information therefrom, any code or the like can be used instead of a QR code.

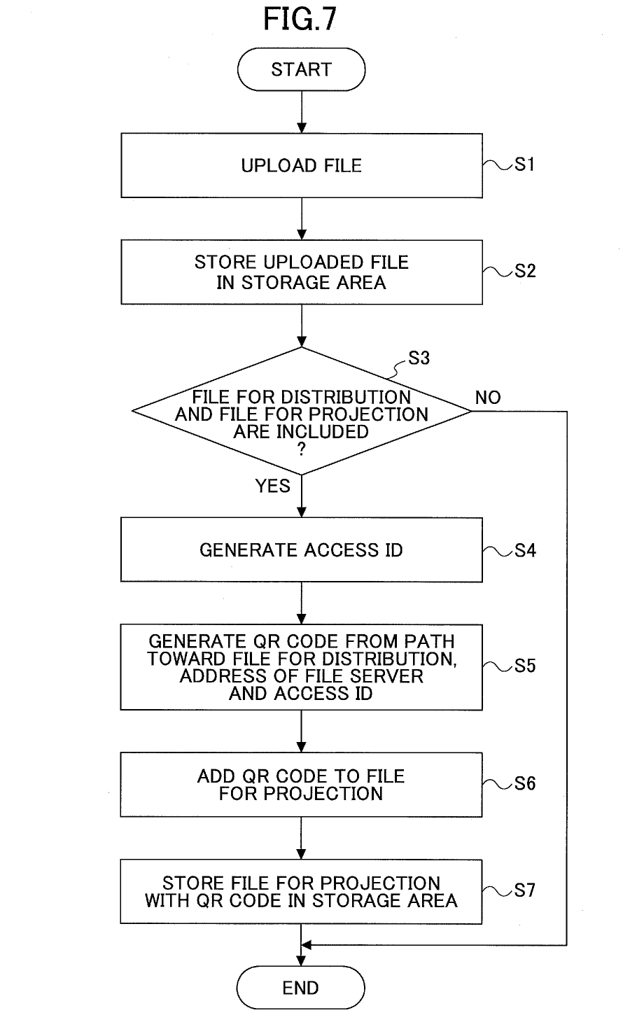

Next, using FIG. 7, a processing example in the file server 100 when the file is uploaded to the file server 100 via the PC 400 by the presenter will be described.

When the file is uploaded (step S1), the file managing part 151 receives the uploaded file, and stores it in the storage area 152 (step S2).

Next, in the above-mentioned case of FIG. 6A, the file managing part 151 refers to the storage area 152 and determine whether, in the folder 600, both the file for distribution 620 and the file for projection 610 are stored (step S3). As specific methods of the determination, the following three methods (1), (2) and (3) can be considered.

(1) From among the files stored in the folder 600, the file having the extension “pdf” is determined as the file for distribution 620 and the file having the extension “ppt” is determined as the file for projection 610.

(2) The file having a file name including a character string “for distribution” is determined as the file for distribution 620 and the file having a file name including a character string “for projection” is determined as the file for projection 610.

(3) The file first (uploaded and) stored is determined as the file for projection 610 and the file subsequently (uploaded and) stored is determined as the file for distribution 620.

When both the file for distribution 620 and the file for projection 610 are not included (step S3, No), the current process is finished only with storing the files in the storage area 152.

When both the file for distribution 620 and the file for projection 610 are included (step S3, Yes), step S4 is then executed in which the file managing part 151 notifies the QR code generating part 153 of the file path toward the file for distribution 620 in the storage area 152. In response to the notification, the QR code generating part 153 requests the access ID from the access control part 154. In response to the request from the QR code generating part 153, the access control part 154 generates the access ID and provides it to the QR code generating part 153.

The QR code generating part 153 uses the file path received form the file managing part 151, the access ID received from the access control part 154 and the IP address of the file server 100 and generates the QR code including these three items of information (step S5) and provides the generated QR code to the image combining part 155.

The image combining part 155 attaches the QR code received from the QR code generating part 153 to the file for projection 630 and provides the file 630 to the file managing part 151 (step S6).

Next, the file managing part 151 stores the file for projection 630 to which the QR code is attached received from the image combining part 155 in the storage area 152 (step S7). As a specific method of the storing of the file, there are the four methods described above using FIGS. 6A, 63, 6C and 6D.

Note that in the respective cases of FIGS. 6B and 6C, step S3 is not provided in flowchart of FIG. 7 and the process directly proceeds to step S4 from step S2. On the other hand, in the case of FIG. 6D, the same procedure as that described above for the case of FIG. 6A is carried out.

In the case of the method of FIG. 6A, the original file for projection 610 is left unchanged and the file for projection with the QR code is stored with another name (630). In this case, when projecting the image of the file, the presenter can selectively determine whether the image of the file 630 with the QR code or the file 610 without the QR code is to be projected.

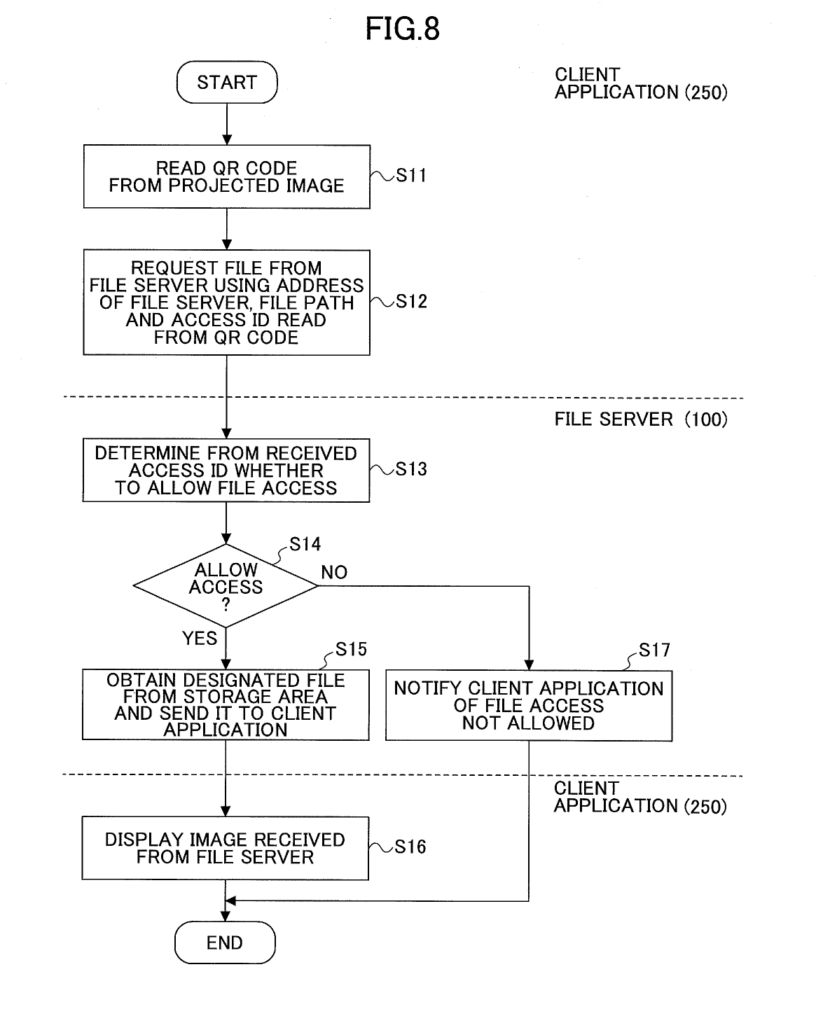

Next, using FIG. 8, a processing example of the client application 250 and the file server 100 when each participant views the file will be described.

In response to the projection request by the presenter through the PC 400, the file managing part 151 in the file server 100 reads the file for projection 630 to which the QR code is added from the storage area 152 and transmits it to the projector 300. In response to the transmission, the projector 300 projects the image 700 of the file for projection 630 on the screen or the like. Each participant uses the own smart device 200 and reads the image 710 of the QR code included in the projected image 700 by using the reading part 208 of the smart device 200 (step S11). That is, the QR code reading part 251 of the client application 250 takes the image 710 of the QR code using the reading part 208.

Next, the QR code reading part 251 obtains the IP address of the file server 100, the file path and the access ID from the taken image 710 of the QR code, in step S12, and provides the obtained information to the file display part 252. The file display part 252 requests the file having the file path received from the QR code reading part 251 from the file server 100 having the IP address received from the QR code reading part 251. In other words, the file display part 252 sends the corresponding file request to the file server 100. At this time, the file display part 252 also transmits the access ID received from the QR code reading part 251 to the file server 100.

The file managing part 151 in the file server 100 receives the file request and provides the received access ID to the access control part 154 (step S13). The access control part 154 determines from the access ID whether to allow access to the file for distribution by the smart device 100 that requested the file. The specific examples of the determination as to whether to allow access have been described above.

When the access control part 154 determines not to allow access (step S14, No), the file managing part 151 sends a notification indicating this point to the client application 250 of the smart device 200 that requested the file (step S17).

On the other hand, when the access control part 154 determines to allow access (step S14, Yes), the file managing part 151 reads the requested file from the storage area 152 and returns it to the client application 250 of the smart device 200 that requested the file (step S15). Alternatively, the file managing part 151 allows the smart device 200 that requested the file to access the requested file stored in the storage area 152. Note that the requested file is the file for distribution 620 in the cases of FIGS. 6A, 6B and 6D and is the file for distribution 630 that is also used as the file for projection in the case of FIG. 6C.

Next, in step S16, the file display part 252 in the client application 250 in the smart device 200 displays the file provided (received) from the file server 100 in step S15 on the LCD 206. Alternatively, the file display part 252 accesses the file in the storage area 152 for which access is allowed in step S15 and displays the file on the LCD 206. As a result, the participant who is the user of the smart device 200 can view the requested file on the LCD 206.

Thus, according to the first embodiment, each participant can view the material for distribution (620 or 630) on the own device (smart device 200) only by reading the image 710 of the QR code from the projected image 700.

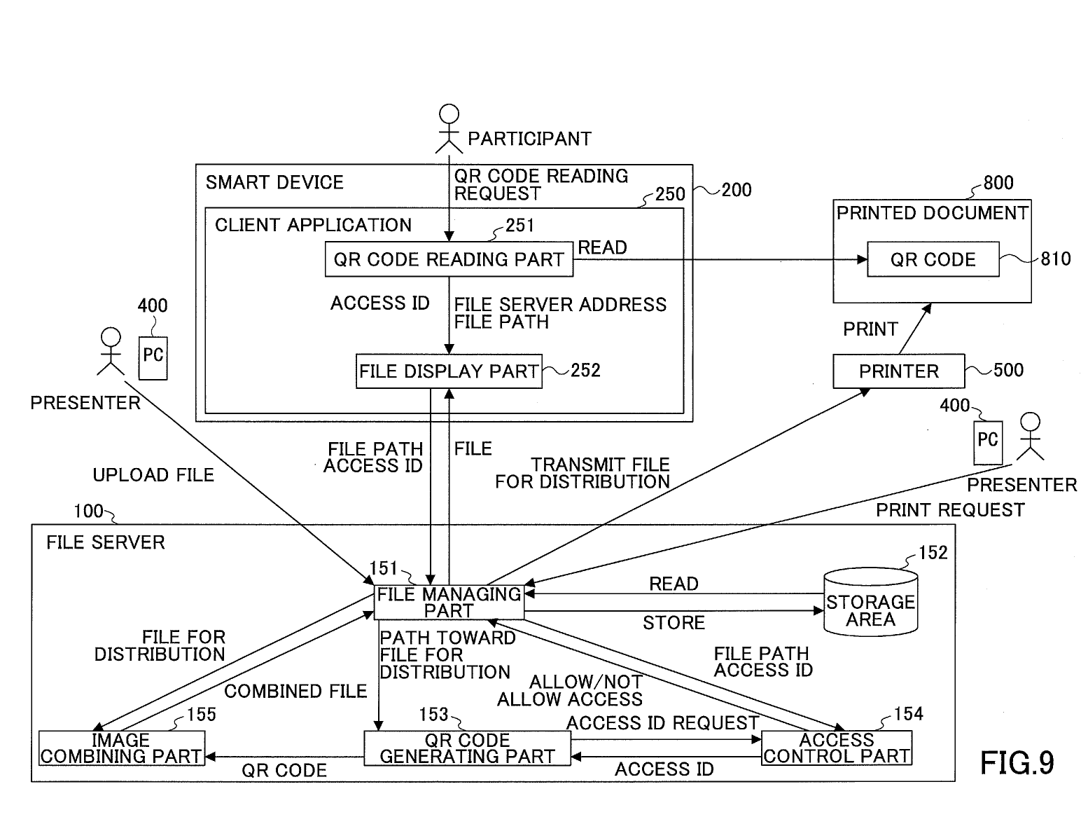

Next, the second embodiment will be described using FIGS. 9-11.

In the first embodiment, the projector 300 projects the projected image 700 including the image 710 of the QR code on the screen or the like and each participant takes the projected image 710 of the QR code using the own smart device 200. In contrast thereto, according to the second embodiment, the presenter uses the printer 500 to print the file and distributes thus-obtained printed documents (distribution material) 800 to the respective participants. Note that in the file to be thus distributed, the image 810 of the QR code is included. When each participant needs an electronic file of the thus-distributed printed document 800 in addition to the printed document 800, the participant takes the image 810 of the QR code included in the printed document 800 and sends a file request to the file server 100 in the same manner as the first embodiment. The file server 100 carries out the same procedure as the first embodiment to allow access, i.e., return the requested file to the smart device 200 that requested it or allow access to the requested file by the smart device 100 that requested it.

Below, description will be made in a manner of focusing on points different from the first embodiment.

Functional configuration examples of a smart device 200 and a file server 100 shown in FIG. 9 are the same or similar to those of the first embodiment shown in FIG. 5. However, as mentioned above, what is different is that the QR code reading part 251 in the smart device 200 reads the image 810 of the QR code included in the printed document 800 instead of reading the image 710 of the QR code included in the projected image 700.

Further, the image combining part 155 in the file server 100 receives the file for distribution from the file managing part 151 instead of the file for projection, combines the image 810 of the QR code therewith and provides the file to the file managing part 151. The file managing part 151 transmits the file for distribution with which the image 810 of the QR code is thus combined to the printer 500 in response to a print request from the presenter via the PC 400. The printer 500 receives the file for distribution with which the image 810 of the QR code is combined, prints the file and thus produces the printed document 800 including the image 810 of the QR code.

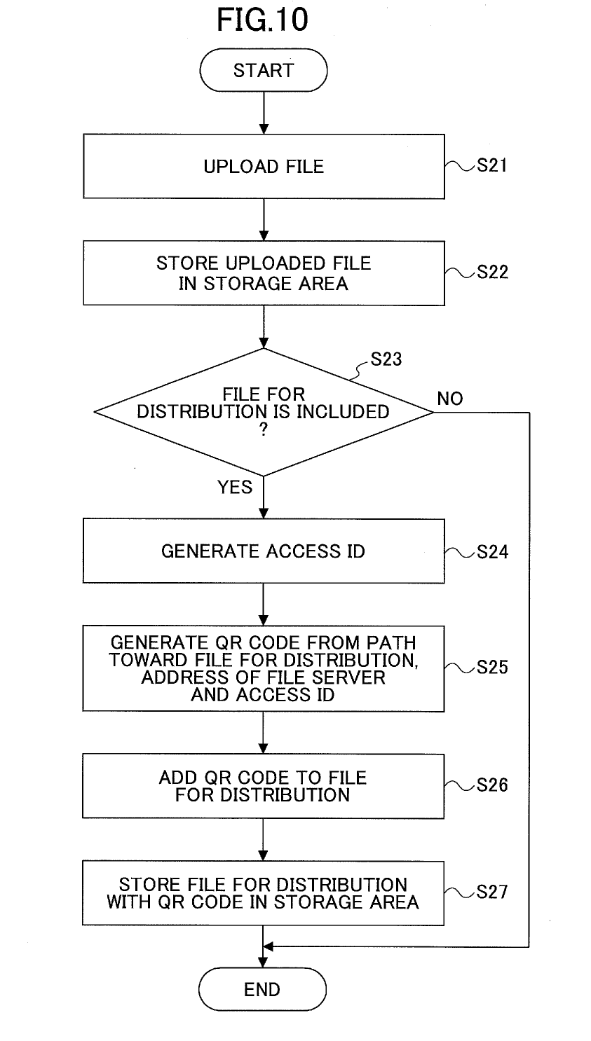

Further, processing, shown in FIG. 10, carried out when the presenter uploads the file to the file server 100 is similar to the first embodiment shown in FIG. 7. That is steps S21, S24 and S25 in FIG. 7 have the same contents as steps S1, S4 and S5.

In step S22, the presenter uses the PC 400 and uploads the file for distribution to the file server 100.

In step S23, the file managing part 151 in the file server 100 determines whether the uploaded file is the file for distribution. Specific examples of the determination are the following examples (1), (2) and (3).

(1) The uploaded file having the extension “pdf” is determined as the file for distribution.

(2) The uploaded file having the file name including a character string “for distribution” is determined as the file for distribution.

(3) All the files stored in a predetermined folder in the storage area 152 are determined as the files for distribution and the image 810 of the QR code is pasted only to each of files to which the QR code can be pasted. The determination as to whether the QR code can be pasted is carried out as follows. That is, first, a case will be assumed that, in the file server 100, no application program that can open a PPT file is installed but an application that can open a PDF file is installed, for example. In this case, it is possible to add the QR code to a PDF file after opening it. On the other hand, unless an application of PowerPoint, for example, is separately installed or the like, it is not possible to open a PPT file and add the QR code thereto. Therefore, the image 810 of the QR code is added to a file to which the file server 100 can add the image 810 of the QR code without installing a new application or the like.

Returning to the description of FIG. 10, in step S26, instead of the file for projection, the image 810 of the QR code is added to the file for distribution. In step S27, the file for distribution to which the image 810 of the QR code is thus added is stored in the storage area 152. Also in this case, the same as the first embodiment, it is possible that the file for distribution with the QR code and the (original) file for distribution without the QR code are stored in the storage area 152 with different names, respectively. In this case, when printing the file, the presenter can selectively determine whether the image of the file with the QR code or the file without the QR code is to be printed.

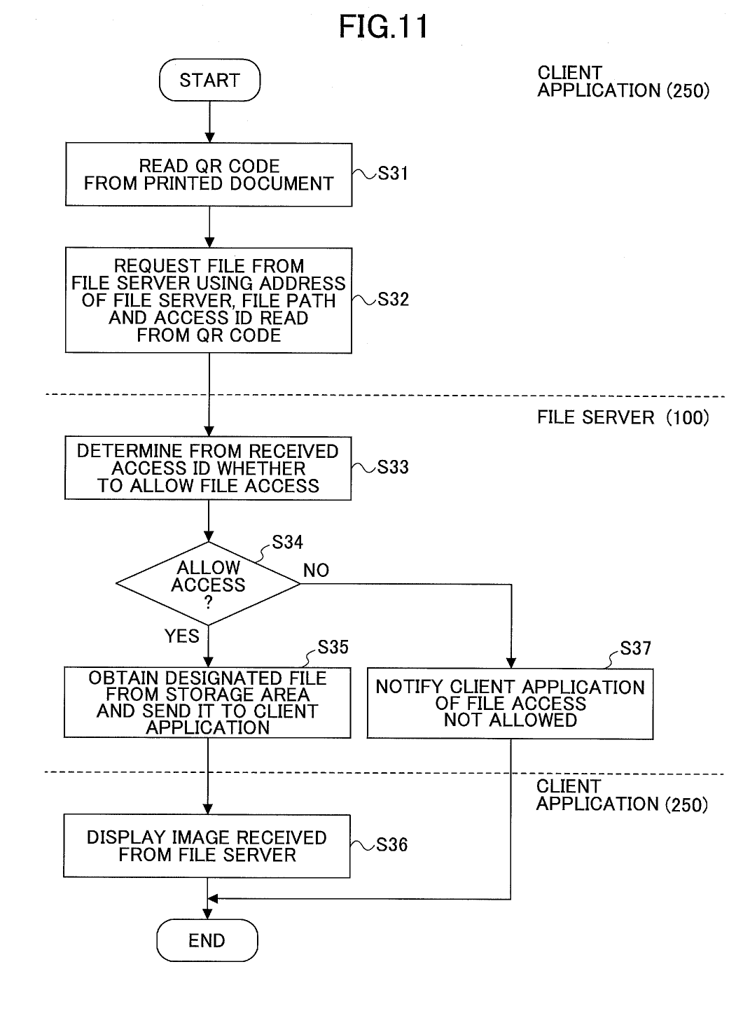

FIG. 11 is a flowchart showing a processing example of the client application 250 and the file server 100 when each participant obtains an electronic file of the printed document 800.

The flowchart of FIG. 11 is similar to that of the first embodiment shown in FIG. 8. That is, steps S32-S37 have the same contents as steps S12-S17 in FIG. 8.

In step S31, the QR code reading part 251 in the client application 250 takes (reads) the image 810 of the QR code included in the printed document 800 through the reading part 208 according to operations of the participant who is the user. The client application 250 obtains the necessary information (three items of information) from the thus read image 810 of the QR code in the same manner as the first embodiment and sends a file request to the file server 100 (step S32). The file server 100 received the file request and determines whether to allow access in the same manner as the first embodiment. When the determination result indicates to allow access, the file server 100 returns the requested file for distribution to the smart device 200 that requested it (steps S33-S36). Alternatively, the file server 100 allows access to the requested file for distribution in the storage area 152 by the smart device 200 that requested it. When the file server 100 does not allow access, the file server 100 sends a notification indicating this point to the smart device 200 (step S37).

Thus, according to the second embodiment, the presenter prints the file to which the image 810 of the QR code is added through the printer 500 and the printed documents 800 are distributed to the respective participants. Each participant can obtain the electronic data of the printed document 800 only by reading the image 810 of the QR code through the smart device 200.

Note that according to the second embodiment, the file to use is one sort thereof, i.e., the file for distribution. The file for distribution is one example of a first file and also is one example of a combined file.

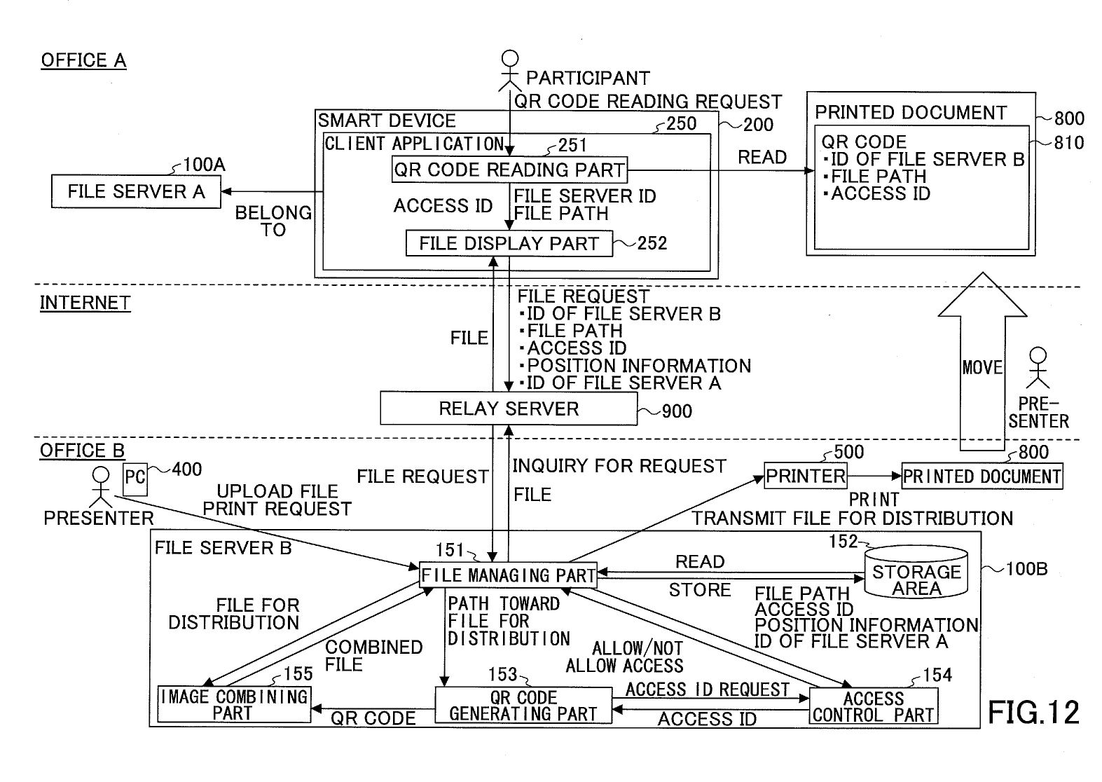

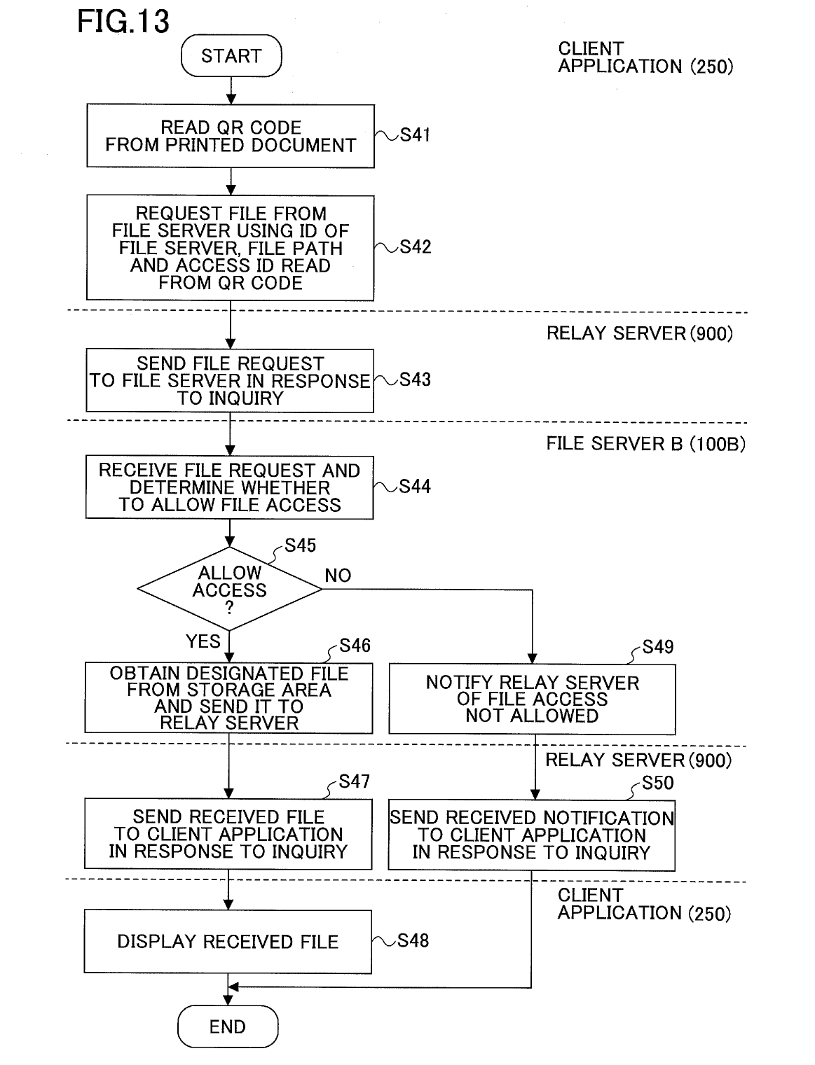

Next, the third embodiment will be described using FIGS. 12-13.

In the first and second embodiments, the client application 250 in the smart device 200 sends a file request to the file server 100 directly, receives a file from the file server 100 and displays it. However, assuming a case where the smart device 200 is not connected with the same network with which the file server 100 is connected, it may be impossible that the smart device 200 carries out communication with the file server 100 directly. That is, in some case, due to the function of a firewall provided in a network with which the file server 100 is connected, it may be impossible that the smart device 200 outside the network carries out communication directly with the file server 100.

According to the third embodiment, as shown in FIG. 12, the client application 250 in the smart device 200 in an office A sends a file request to a file server B (100B) installed in an office B via a relay server 900 connected with the Internet. As a result, even in such an environment in which the smart device 200 cannot carry out communication with the file server 100B directly, the client application 250 can send a file request to the file server 100B and receive a file from the file server 100B via the relay server 900.

Also in the third embodiment, in the same manner as the second embodiment, the presenter uses the printer 500, prints the file and obtains the printed documents 800. Then, the presenter brings the printed documents 800 from the office B in which the printing was carried out to the other office A and distributes the printed documents 800 to the respective participants. Then, each participant causes the own smart device 200 to reads the QR code included in the printed document 800 in the office A. As a result, the client application 250 in the smart device 200 obtains the file (in an electronic version) from the file server B (100B) in the office B via the relay server 900.

Below, the third embodiment will be described in a manner of focusing on differences from the second embodiment.

Functional configuration examples of the smart device 200 and the file server B (100B) in the third embodiment shown in FIG. 12 are similar to the functional configuration examples of the smart device 200 and the file server 100 in the second embodiment shown in FIG. 9. However, the following points are different therebetween. That is, according to the third embodiment shown in FIG. 12, the file display part 252 in the client application 250 sends a file request to the relay server 900. Further, the file server B (100B) inquires of the relay server 900 whether to have a file request. Then, when the file server B (100B) has the file request, the file server B (100B) returns a file to the relay server 900 according to the file request.

Note that, according to the third embodiment, the QR code included in the printed document 800 includes the file server ID of the file server B (100B). Then, the client application 250 adds the file server ID to the file request and sends the file request to the relay server 900. In a case where the relay server 900 has the file request to which the file server ID of the file server B (100B) is thus added when receiving the inquiry from the file server B (100B) as to whether to have a file request, the relay server 900 returns the file request to the file server B (100B). As a result, it is possible to positively provide the file request from the client application 250 to the corresponding file server B (100B).

Further, as specific methods of access control according to the third embodiment, either one of the following access control methods (i) and (ii) can be used.

The access control method (i) is such a method that access is controlled depending on the position of the smart device 200 in which the client application 250 is installed when the client application 250 sends the file request.

That is, when the file is uploaded and the access ID is generated (see step S24 in the second embodiment shown in FIG. 10), an accessible area is provided for each access ID.

Then, when the client application 250 sends the file request, the client application 250 obtains the position information of the smart device 200 in which the client application 250 is installed and transmits the thus obtained position information together with the file request. As the position information of the smart device 200, it is possible to use position information obtained through a GPS function of the smart device 200, if any, for example.

The access control part 154 in the file server B (100B) reads the access ID and the position information thus transmitted together with the file request and determines whether the received file request is a file request from the accessible area previously provided for the access ID. That is, it is determined whether the position indicated by the position information is included in the accessible area previously provided for the access ID (corresponding to step S45 in FIG. 13 described later). When the determination result indicates that the file request is sent from the accessible area, the file server B (100B) returns the file (corresponding to step S46 in FIG. 13). On the other hand, when the determination result indicates that the file request is not sent from the accessible area, access to the file is not allowed (corresponding to step S49 in FIG. 13).

Note that, in this access control method (i), the accessible area is provided for each access ID. However, it is also possible that a common accessible area can be provided for the file server B (100B). In this case, the file server B (100B) returns the file in response to the file request from the common accessible area (corresponding to step S46 in FIG. 13). On the other hand, the file server B (100B) does not allow access to the file in response to the file request from the outside of the common accessible area (corresponding to step S49 in FIG. 13).

Next, the above-mentioned access control method (ii) is such a method that access is controlled depending on the file server ID of the file server to which the client application 250 that sends the file request belongs.

According to the access control method (ii), the client applications 250 of the respective smart devices 200 are previously registered with the file servers that the client applications 250 normally access, respectively. As a result, each client application 250 belongs to any one of the file servers. For example, it is assumed that the client application 250 belongs to the file server A (100A) (see FIG. 12). Then, when the file is uploaded to the file server B (100B) and the file server B (100B) generates the access ID therefor (see step S24 in FIG. 10), the file server B (100B) previously determines, for the access ID, one from among the file servers for allowing access from the client application 250 that belongs to the determined file server.

Then, when the client application 250 sends the file request, the client application 250 sends the file server ID of the file server to which the client application 250 belongs with the file request. The access control part 154 in the file server B (100B) reads the access ID and the file server ID of the file server to which the client application 250 belongs thus transmitted with the file request and determines whether the file server ID of the file server to which the client application 250 belongs is coincident with the file server ID predetermined for the access ID as mentioned above (corresponding to step S45 mentioned above). When they are coincident with one another, the file server B (100B) returns the file (corresponding to step S46 mentioned above). On the other hand, when they are not coincident with one another, the file server B (100B) does not allow access to the file (corresponding to step S49 mentioned above).

Note that in the access control method (ii), the accessible file server is determined for each access ID. However, it is also possible that a common accessible file server is determined for the file server B (100B). In this case, the file server B (100B) returns the file in response to the file request from the client application 250 that belongs to a file server determined in common for the file server B (100B) (corresponding to step S46). On the other hand, the file server B (100B) does not allow access to the file in response to the file request from the client application 250 that belongs to a file server other than a file server determined in common for the file server B (100B) (corresponding to step S49).

According to the respective access control methods (i) and (ii) in the third embodiment described above, it is possible to prevent or control unauthorized access to the file server B (100B) by a third party even when, for example, the presenter misses the printed document 800 while moving between offices.

That is, a case will now be assumed where the third party obtains the missed printed document 800, uses an own smart device to read the QR code on the printed document 800 and sends a file request to the file server B (100B) through the smart device. In this case, according to the above-mentioned access control method (i), when the position of the smart device of the third party at the time of sending the file request is not included in the accessible area previously provided for the access ID added to the file request, the file server B (100B) does not allow access to the file by the third party (corresponding to step S49).

That is, in the case of the access control method (i), the accessible area previously provided for each access ID or the accessible area common to the file server B (100B) is previously announced to the respective participants. As a result, each participant can obtain the file from the file server B (100B) by sending the file request from the announced accessible area using the own smart device 200. On the other hand, since the third party does not know the accessible area, there is a strong likelihood that the third party sends the file request from the outside of the accessible area, and as a result, there is a strong likelihood that the access is not allowed. Thus, it is possible to effectively prevent or control unauthorized access.

Concerning the above-mentioned access control method (ii), a case will now be assumed where the third party obtains the missed printed document 800, uses an own smart device to read the QR code on the printed document 800 and send a file request to the file server B (100B). In this case, according to the above-mentioned access control method (ii), when the file server to which the client application of the third party belongs is not coincident with the file server previously determined for the access ID added to the file request, the file server B (100B) does not allow access to the file (corresponding to step S49).

That is, in the case of the access control method (ii), the file server previously determined for each access ID is made coincident with the file server to which the client application 250 of the smart device 200 of each participant belongs. As a result, each participant can obtain the file from the file server B (100B) by sending the file request using the own smart device 200. On the other hand, there is a strong likelihood that the file server previously determined for each access ID is not coincident with the file server to which the client application of the smart device of the third party belongs. Therefore, there is a strong likelihood that the access is not allowed when the file request is sent from the smart device of the third party. Thus, it is possible to effectively prevent or control unauthorized access.

Further, instead of carrying out such access control, the file server B (100B) can store information received together with the file request as an access log. That is, the position information of the smart device that changes along with a movement of the smart device or the file server ID of the file server to which the client application of the smart device belongs can be stored. In particular, by using the file server ID of the file server to which the client application belongs, it is possible to identify the person who carries out unauthorized access, if any. That is, by using the file server ID of the file server to which the client application of the smart device belongs, it is possible to identify the file server to which the client application of the smart device used at the time of the unauthorized access. Therefore, by thus finding out the client application that belongs to the identified file server, it is possible to identify the unauthorized access person.

FIG. 13 is a flowchart showing a processing example in the client application 250 and the file server B (100B) when each participant obtains the electronic file of the printed document 800 according to the third embodiment.

In step S41, the QR code reading part 251 in the client application 250 takes (reads) the image 810 of the QR code included in the printed document 800 through the reading part 208 of the smart device 200 in response to operations of the participant who is the user. The client application 250 obtains the necessary information (three items of information) from the read image 810 of the QR code in the same procedure as the second embodiment and sends the file request to the relay server 900 (step S42). However, according to the third embodiment, instead of the IP address of the file server B (100B), the file server ID of the file server B (100B) is used. Therefore, the above-mentioned three items of information includes the file path, the access ID and the file server ID of the file server B (100B).

The client application 250 further adds “the position information” or “the server ID of the file server A (100A) (to which the client application 250 belongs)”, according to one of the above-mentioned access control methods (i) and (ii), to the file request when sending the file request in step S42.

The relay server 900 receives the file request and stores the received file request. Then, the relay server 900 receives an inquiry from the file server B (100B) as to whether to have a file request. The relay server 900 returns the file request to which the file server ID of the file server B (100B) coincident with the file server ID of the file server that sent the inquiry is added to the file server B (100B) (step S43).

Then, the file server B (100B) uses “the position information” or “the file server ID of the file server A (100A)” according to the access control method and determines whether to allow access (step S45). When allowing access as a result (YES), the file server B (100B) obtains the requested file for distribution in the same way as in step S35 (see FIG. 11) in the second embodiment. Then, the file server B (100B) returns the obtained file to the relay server 900 (step S46).

Then, in step S46, the relay server 900 stores the file received from the file server B (100B) as corresponding to the file request sent in step S43 to the file server B (100B). Then, after receiving an inquiry from the client application 250 that sent the file request as to whether to have the file, the relay apparatus 900 returns the file stored in step S46 to the client application 250 (step S47).

Then, the client application 250 displays the file transmitted from the relay server 900 in the same way as in step S36 in the second embodiment (see FIG. 11) (step S48).

On the other hand, when not allowing access as a result of the determination in step S45, the file server B (100B) returns a notification indicating not allowing access to the relay server 900 (step S49).

The relay server 900 stores the notification indicating not allowing access transmitted from the file server B (100B) in step S49 as corresponding to the file request transmuted to the file server B (100B) in step S43. Then, when receiving an inquiry from the client application 250 that sent the file request as to whether to have the file, the relay server 900 returns the notification indicating not allowing access stored as mentioned above to the client application 250 (step S50).

Note that the inquiry in step S43 from the file server B (100B) as to “whether to have a file request” is, for example, periodically sent by the file server B (100B), for example. Similarly, the inquires in steps S47 and S50 from the client application 250 as to “whether to have the file” is, for example, periodically sent by the client application 250, for example.

Thus, the information processing apparatus, the information processing system, and the information processing method have been described in the embodiments. However, the present invention is not limited to the specifically disclosed embodiments and variations and modifications may be made without departing from the scope of the present invention.

For example, in the above-mentioned embodiments, the file managing part 151, the storage area 152, the QR code generating part 153, the access control part 154 and the image combining part 155 are included in the single file server 100 (or 100B). However, embodiments are not limited thereto. That is, the file managing part 151, the storage area 152, the QR code generating part 153, the access control part 154 and the image combining part 155 can be provided in two or more servers in a dispersed manner, which servers are connected together in a mutually communicatable by a network.

Further, in the above-mentioned embodiments, the projector 300 or the printer 500 is separate from the file server 100 (or 100B). However, embodiments are not limited thereto. That is, the respective functions of the projector 300 and the file server 100 can be integrated into a single apparatus. Similarly, the respective functions of the printer 500 and the file server 100 (or 100B) can be integrated into a single apparatus.

Further, the information processing system according to any of the above-mentioned embodiments can have a configuration such that the file server 100 (or 100B) belongs to an organization that provides a cloud service. In this case, for example, to the file server 100 (or 100B), the smart devices 200, the PC 400, the projector 300, the printer 500 and so forth are connected via the Internet. Then, to file server 100 (or 100B), a request such as a projection request, a file request and so forth are sent. As a result, in response to these requests, the file server 100 (or 100B) provides, as cloud services, a service such as transmitting a file for projection, transmitting a file for distribution and so forth.

The present application is based on and claims the benefit of priority of Japanese Priority Application No. 2013-048397, dated Mar. 11, 2013, and Japanese Priority Application No. 2014-037009, dated Feb. 27, 2014, the entire contents of which are hereby incorporated herein by reference.

What is claimed is:

1. An information processing apparatus comprising:
a storing part that stores a first file;
a file obtaining information generating part that generates file obtaining information based on at least a place at which the first file is stored in the storing part;
a combined file generating part that combines the file obtaining information generated by the file obtaining information generating part with the first file or a second file corresponding to the first file to generate a combined file;
a request receiving part that receives a request that is based on the file obtaining information that is input to an external terminal unit by using the combined file generated by the combined file generating part; and
a file managing part that carries out a process according to the request received by the request receiving part.

2. The information processing apparatus as claimed in claim 1, wherein
the process according to the request is a process of transmitting the first file to the external terminal unit.

3. The information processing apparatus as claimed in claim 1, wherein
the file obtaining information further includes validity information that indicates validity for obtaining the first file concerning a predetermined purpose of using the first file.

4. The information processing apparatus as claimed in claim 3, wherein
the external terminal unit transmits the request in which the validity information included in the file obtaining information is included, and
the information processing apparatus has a validity determining part that determines, according to the validity information included in the request, whether to allow execution of the process according to the request.

5. The information processing apparatus as claimed in claim 4, wherein
the validity determining part provides a number of times for allowing execution of the process according to the request for each validity information, and does not execute the process according to the request that includes the validity information after the number of times provided therefor is exceeded.

6. The information processing apparatus as claimed in claim 4, wherein
the validity determining part provides a time for allowing execution of the process according to the request for each validity information, and does not execute the process according to the request that includes the validity information after the time provided therefor is exceeded.

7. The information processing apparatus as claimed in claim 1, wherein
the request receiving part receives the request via a relay server, and
the file managing part returns, via the relay server, a result obtained from the process according to the request being executed.

8. The information processing apparatus as claimed in claim 1, wherein
the request receiving part receives position information of the external terminal unit when receiving the request, and stores the received portion information as an access log.

9. The information processing apparatus as claimed in claim 4, wherein
the request receiving part receives position information of the external terminal unit when receiving the request,
the validity determining part provides a position range for executing the process according to the request for each validity information, and
the information processing apparatus does not execute the process according to the request when the position information received together with the request indicates a position that is outside the position range provided by the validity determining part for the validity information included in the request.

10. The information processing apparatus as claimed in claim 1, wherein
when receiving the request, the request receiving part receives information that indicates an information processing apparatus with which the external terminal unit is registered and stores the received information that indicates the information processing apparatus with which the external terminal unit is registered as an access log.

11. The information processing apparatus as claimed in claim 4, wherein
the request receiving part receives information that indicates an information processing apparatus with which the external terminal unit is registered when receiving the request,
the validity determining part determines for each validity information the information processing apparatus with which the external terminal unit is registered for executing the process according to the request, and
the information processing apparatus does not execute the process according to the request when the information that indicates the information processing apparatus with which the external terminal unit is registered received together with the request indicates the information processing apparatus with which the external terminal unit is registered that is other than the information processing apparatus with which the external terminal unit is registered determined by the validity determining part for the validity information included in the request.

12. The information processing apparatus as claimed in claim 1, further comprising:
a file converting part that converts a format of the first file or the second file into a predetermined format, wherein
the combined file generating part combines the file obtaining information with the file obtained from the file format of the first file or the second file being converted into the predetermined format by the file converting part.

13. An information processing system comprising:
a storing part that stores a first file;
a file obtaining information generating part that generates file obtaining information based on at least a place at which the first file is stored in the storing part;
a combined file generating part that combines the file obtaining information generated by the file obtaining information generating part with the first file or a second file corresponding to the first file to generate a combined file;
a combined file outputting part that outputs the combined file generated by the combined file generating part;
a request transmitting part that transmits a request that is based on the file obtaining information that is input by using the combined file that is output by the combined file outputting part;
a request receiving part that receives the request that is transmitted by the request transmitting part; and
a file managing part that carries out a process according to the request received by the request receiving part.

14. An information processing method comprising:
storing, by one or more processors, a first file in a storing part;
generating, by one or more processors, file obtaining information at based on at least a place at which a first file is stored in the storing part;
combining, by one or more processors, the generated file obtaining information with the first file or a second file corresponding to the first file to generate a combined file;
outputting, by one or more processors, the generated combined file;
transmitting, by one or more processors, a request that is based on the file obtaining information that is input by using the combined file that is output;
receiving, by one or more processors, the transmitted request; and
carrying out, by one or more processors, a process according to the received request.
